(19) United States
(12) Patent Application Publication
(10) Pub. No.: US 2018/0308342 A1
(43) Pub. Date: Oct. 25, 2018

(54) EMERGENCY ALERT SYSTEM FOR CONTROLLED ENVIRONMENT

(71) Applicant: GLOBAL TEL*LINK CORPORATION, Reston, VA (US)

(72) Inventor: Stephen L. HODGE, Aubrey, TX (US)

(21) Appl. No.: 15/496,551

(22) Filed: Apr. 25, 2017

(51) Int. Cl. G08B 25/01; G08B 21/02; G08B 21/04

(52) U.S. Cl. CPC G08B 25/016; G08B 21/0453; G08B 21/0266

(57) ABSTRACT

Methods and systems for providing an emergency alert system in a controlled environment disclosed herein. An emergency alert system receives a distress message from the user device. In some instances, the distress message includes information identifying the location of the user device within the controlled environment, and wellness information captured by the user device. Further, the emergency alert system identifies a user associated with the user device, and presents emergency information corresponding to the user and the location of the user device to the staff of the controlled environment. In some examples, the emergency alert system further determines an emergency response to the distress message based upon the location of the user device and the wellness information.

### FIELD OF THE INVENTION

The invention relates generally to emergency alert systems in penal institutions or similar facilities. In particular, the invention relates to an emergency alert system with the means to receive a distress message from an inmate device and coordinate an emergency response to the distress message.

### BACKGROUND OF THE INVENTION

American prison institutions house millions of individuals in controlled environments all over the country. Modern prison institutions still require inmates to prepare and submit written forms in order to communicate with prison staff and/or administration. Depending upon the nature of an inmate's complaint or concern, a guard may not be immediately available and a written communication may not offer an adequate response to the inmate's request. For instance, a threat of violence or medical emergency may require an immediate response not offered by the methods currently employed within the American prison system.

### BRIEF DESCRIPTION OF THE DRAWINGS

A further understanding of the invention can be obtained by reference to a preferred embodiment set forth in the illustrations of the accompanying drawings. Although the illustrated embodiment is merely exemplary of systems for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the invention, reference is now made to the following drawings in which:

FIG. 1 depicts an example framework for providing an emergency alert system in a controlled environment, according to some implementations.

FIG. 2 depicts an example framework for providing an emergency alert system in a controlled environment, according to some implementations.

FIG. 3 depicts an example graphical user interface for providing an emergency response in a controlled environment, according to some implementations.

FIG. 4 is a flow diagram illustrating an example process for providing an emergency response within a controlled environment according to some implementations.

FIG. 5 illustrates select components of an example emergency management server, according to some implementations.

FIG. 6 illustrates select components of an example inmate device, according to some implementations.

### DETAILED DESCRIPTION OF THE DRAWINGS

As required, a detailed illustrative embodiment of the invention is disclosed herein. However, techniques, systems and operating structures in accordance with the invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the invention. The following presents a detailed description of the preferred embodiment of the invention.

For purposes of this discussion, any reference to the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the disclosure that others can, by applying knowledge of those skilled in relevant art(s), readily modify and/or customize for various applications such exemplary embodiments, without undue experimentation, without departing from the spirit and scope of the disclosure. Therefore, such modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

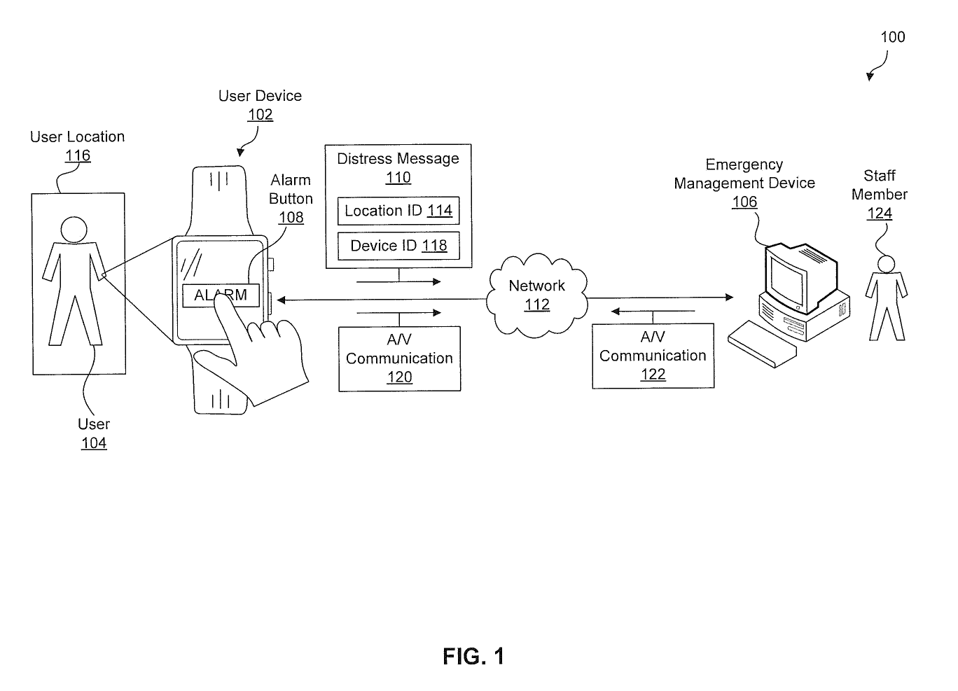

FIG. 1 illustrates an example framework for providing an emergency alert system 100 in a controlled environment, according to some implementations. FIG. 1 shows illustrative interactions within the controlled environment between a user device 102 associated with a user 104, and an emergency management device 106. Some examples of the user device 102 include wearable computing devices, smart phones and mobile communication devices; tablet computing devices; desktops, laptops, netbooks and other portable computers, and any other portable device capable of sending communications to the emergency management device 106. As described herein, a wearable device also refers to devices that are inserted into a human body.

As shown in FIG. 1, the user 104 activates an alarm button 108 on the user device 102. For instance, the user 104 may experience one or more symptoms of cardiac arrest, and press the alarm button 108 on the user device 102. In some examples, the alarm button 108 is a control presented by a graphical interface of the user device 102. In some other examples, the alarm button 108 is a physical button of the user device 102. In yet still some other examples, activation of the alarm button 108 occurs in response to gesture input, audio input, and/or camera input. As defined herein, gestures include any combination of tapping, pressure, waving, lifting or other type of motions on or near the surface of a touch screen. Such gestures when performed in a certain order and/or pattern will be interpreted as a particular input.

Although FIG. 1 illustrates a single alarm button 108, the user device 102 may include a plurality of alarm buttons. Further, individual alarm buttons of the plurality of alarm buttons may be associated with different types of emergencies. For example, the user device 102 may provide a first alarm button for medical emergencies and a second alarm button for non-medical emergencies.

Upon activation of the alarm button 108, the user device 102 transmits a distress message 110 to the emergency management device 106 via the network 112. The network 112 may include any or all of a private network, personal area network (PAN), Local-Area Network (LAN), a Wide-Area Network (WAN), or the Internet. Further, the connection between the user device 102 and the network 112 may be a wireless connection (e.g., Bluetooth™, Wi-Fi connection, etc.), or a wired connection (e.g., Ethernet, universal serial bus (USB), etc.). The distress message 110 includes a location identifier 114 that identifies a location 116 of the user device 102, and a device identifier 118 that identifies the user device 102. The location identifier 114 includes a name, coordinate, positional descriptor, or any other information capable of identifying the location 116 of the user device 102 within the controlled environment. As described herein, the location includes a position of the user device 102 when the alarm button is activated, a position of the user device 102 when the distress message 110 is transmitted, and/or one or more positions in proximity to the user device 102.

In some instances, the user device 102 determines the location 116 of the user device 102. For example, the user device 102 utilizes a global positioning system (GPS) functionality to determine the location 116 of the user device 102. As another example, the user device 102 determines the location 116 of the user device 102 by reading scannable indicia associated with the location 116, and/or receiving a signal from a location beacon. For instance, the location 116 may contain a Radio Frequency Identifier Device (RFID) tag that identifies the location 116. Further, the user device 102 reads the RFID tag to determine the location 116 of the user device 102.

In some examples, the device identifier 118 is a globally unique identifier assigned to the user device 102 within the controlled environment. Further, the user device 102 stores the device identifier 118 in a memory component of the user device 102. In some instances, the device identifier 118 includes an identifier assigned by a manufacturer of the user device 102. In some other instances, the device identifier 118 is assigned by the emergency management device 106.

Upon receipt of the distress message 110, the emergency management device 106 establishes a two-way communication channel with the user device 102. As shown in FIG. 1, the two-way communication channel permits the emergency management device 106 to send audio/visual communication 120 to the user device 102, and permits the user device 102 to send audio/visual communication 122 to the emergency management device 106. The two-way communication channel allows a staff member 124 of the controlled environment to speak to the user 104 of the user device 102, and/or observe the user 104 of the user device 102. As such, the staff member 124 may take immediate action to attend to the concerns and/or needs of the user 104. For example, the user 104 may communicate via the audio/visual communication 122 that the user 104 is experiencing one or more symptoms of cardiac arrest. In response, the staff member 124 within the controlled environment may provide first aid instructions and/or coordinate an emergency response. Conversely, the staff member 124 may determine that the distress message 110 was inadvertent or specious based on the audio/visual communication 122 received from the user device 102.

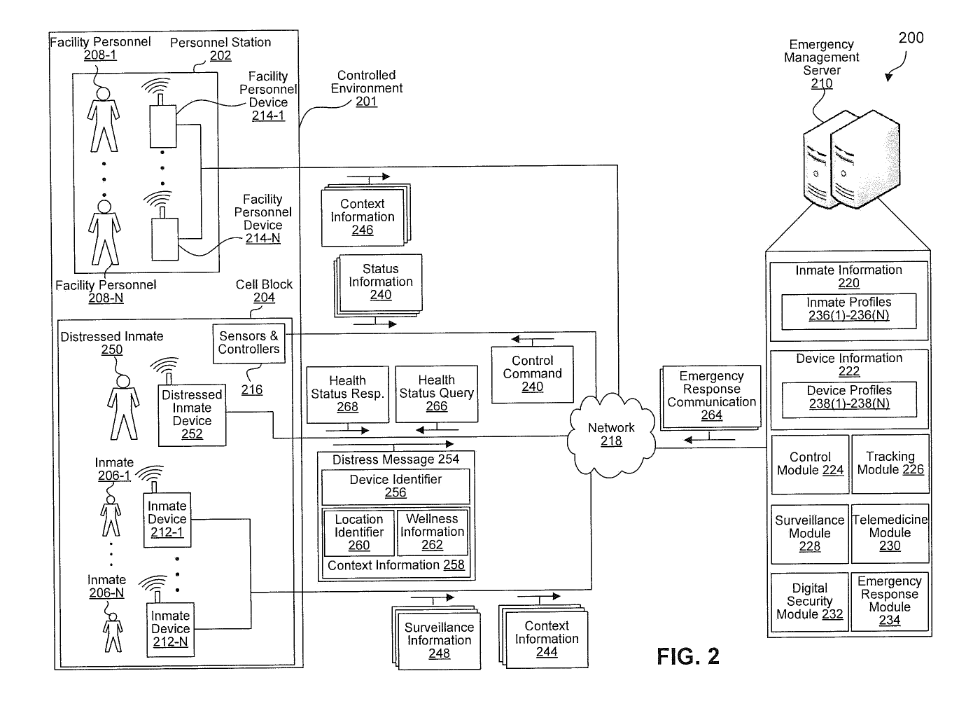

FIG. 2 illustrates an example framework for providing an emergency alert system 200 within a controlled environment 201 (e.g., correctional facility, detention center, etc.). The controlled environment 201 is arranged into areas, stations, or regions associated with various functions. As shown in FIG. 2, the controlled environment 201 is physically and/or logically organized to include a personnel station 202 and a cell block 204. Additionally, or alternatively, the controlled environment 201 may include a dining hall, commissary, library, exercise yard, hallway(s), etc.

In addition, one or more inmates 206 may be confined to the controlled environment 201. Further, the inmates 206 may be assigned to prison cells located in the cell block 204. Additionally, one or more facility personnel 208 may be employed at the controlled environment 201. Some examples of facility personnel 208 may include correctional officers, medical staff, custodial staff, administrative staff, contractors, etc. The facility personnel 208 may be responsible for monitoring the safety and/or well-being of the inmates 206. In some examples, the facility personnel 208 may monitor the inmates 206 from the personnel station 202. Furthermore, the facility personnel 208 may patrol the controlled environment 201 in order to ensure the safety and well-being of the inmates 206. Additionally, or alternatively, the facility personnel 208 may remotely monitor the inmates 206.

As shown in FIG. 2, the emergency alert system 200 includes an emergency management server 210, one or more inmate devices 212, one or more facility personnel devices 214 (e.g., medical personnel device, security personnel device, etc.), and sensors and controllers 216. Individual facility personnel 208 are associated with particular facility personnel devices 214. For example, a first member of the facility personnel 208(1) is associated with a first facility personnel device 214(1), an Nth member of the facility personnel 208(N) is associated with a Nth facility personnel device 214(N), and so forth. Additionally, individual inmates 206 are associated with particular inmate devices 212. For example, a first inmate 206(1) is associated with a first inmate device 212(1), an Nth inmate 206(N) is associated with a Nth inmate device 212(N), and so forth. Further, the cell block 204 includes the sensors and controllers 216 to monitor and administer the cell block 204. Some examples of sensors and controllers 216 include surveillance cameras, thermostats, network access points, location beacons, door controllers, lighting controllers, sprinkler system controllers, etc.

As illustrated in FIG. 2, the emergency management server 210, the inmate devices 212, the facility personnel devices 214, and the smart sensors and controllers 216 are coupled via a network 218. The coupling between the emergency management server 210 and any other components of the emergency alert system 200 may be via wired technologies, wireless technologies (e.g., radiofrequency (RF), cellular, satellite, Bluetooth, etc.), or other connection technologies.

The emergency management server 210 includes inmate information 220, device information 222, a control module 224, a tracking module 226, a surveillance module 228, a telemedicine module 230, a digital security module 232, and an emergency response module 234.

The emergency management server 210 maintains inmate information 220 in the form of inmate profiles 236 corresponding to the inmates 206. For example, the first inmate profile 236(1) is associated with the first inmate 206(1), the Nth inmate profile 236(N) is associated with the Nth inmate 206(N), and so forth. In some instances, the inmate profiles 236 include information from one or more of a jail management system (JMS) or an offender management system (OMS), a public database containing information on the inmates 206, a personal approved number (PAN) list, or booking information. Further, in some instances, the inmate profiles 236 include personal information such as previous residences or correctional facilities, authorized contacts, family members, languages, special needs, medical history, medication requirements, inmate device usage, incident reports, etc.

Additionally, the emergency management server 210 maintains device information 222 in the form of inmate device profiles 238 corresponding to the inmate devices 212. For example, the first inmate device profile 238(1) is associated with the first inmate device 212(1), the Nth inmate device profile 238(N) is associated with the Nth inmate device 212(N), and so forth. In some instances, the inmate device profiles 238 include a device name, a device manufacturer, firmware identifier, operating system identifier, upgrade history, device capabilities, installed applications, and/or device usage history. Further, in some instances, the inmate device profile 238 identifies an inmate 206 currently in possession of the inmate device 212, and/or the current location of the inmate device 212.

The control module 224 sends control commands 240 to the sensors and controllers 216. For example, the control module 224 sends control commands 240 (e.g., instructions to pan, tilt, and/or zoom) to the surveillance camera 216 within the controlled environment 201. As another example, the control module 224 sends control commands 240 to the door controllers 216 to open or close doors within the controlled environment 201. Further, the control module 224 receives status information 242 from the sensors and controllers 216 throughout the controlled environment 201. For instance, the control module 224 receives status information 242 communicating the current temperature and/or humidity of the cell block 204. As yet still another example, the control module 224 receives status information 242 from door controllers indicating that individual doors have been opened or closed within the cell block 204. Additionally, or alternatively, the control module 224 may receive a request to open the door in the cell block 204, and respond with a control command 240 to open the door in the cell block 204.

The tracking module 226 monitors the location of the inmates 206 and the facility personnel 208 within the controlled environment 201. In some instances, the tracking module 226 relies on the status information 242 to determine the location of the inmates 206 and the facility personnel 208. For example, the sensors and controllers 216 identify inmates 206 within the cell block 204 of the controlled environment 201, and send status information 242 to the tracking module 226 indicating the presence of the inmates 206 within the cell block 204. In some cases, the sensors and controllers 216 identify the inmates 206 using readable indicia (e.g., RFID) associated with individual inmates 206.

In some other instances, the tracking module 226 relies on the inmate devices 212 and facility personnel devices 214, respectively, to determine the locations of the inmates 206 and the facility personnel 208 within the controlled environment 201. As illustrated in FIG. 2, the inmate devices 212 send context information 244 to the emergency management server 210 via the network 218, and the facility personnel devices 214 send context information 246 to the emergency management server 210 via the network 218. Further, the context information 244 includes location information (e.g., GPS coordinates) indicating the current location of individual inmate devices 212. Similarly, the context information 246 includes location information indicating the current location of individual facility personnel devices 214.

In some instances, the tracking module 226 determines a location of the inmate 206(1) based at least in part on the location information included in the context information 244 received from the inmate device 212(1), and the current user of the inmate device 212(1) as identified in the device profile 238(1). Additionally, or alternatively, the context information 244 may directly identify the inmate 206(1). For example, the context information 244 may include an inmate identifier that identifies the inmate 206(1).

The surveillance module 228 presents the status information 242 to the facility personnel 208. For example, the surveillance module 228 sends status information 242 (e.g., audio-video capture) received from the sensors and controllers 216 to the facility personnel devices 214. As another example, the surveillance module 228 displays the status information 242 on one or more display monitors connected to the emergency management server 210.

Additionally, the surveillance module 228 activates surveillance capabilities of the inmate devices 212 and/or the facility personnel devices 214. For example, the surveillance module 228 requests that the inmate device 212(1) provide surveillance information 248 using one or more components (e.g., microphone, camera, etc.) of the inmate device 212(1). Further, the inmate device 212(1) transmits the surveillance information 248 to the surveillance module 228. Additionally, the surveillance module 228 presents the surveillance information 248 to the facility personnel 208. In some examples, the surveillance module 228 determines the capabilities of an inmate device 212(1) based on the inmate device profile 238(1). If the inmate device 212(1) has surveillance capabilities, the surveillance module 228 requests the surveillance information 248 from the inmate device 212(1).

Further, the surveillance module 228 analyzes the status information 242 collected by the sensors and controllers 216, the context information 244 provided by the inmate devices 212, and/or the context information 246 provided by the facility personnel devices 214. For instance, the surveillance module 228 identifies potentially suspicious or dangerous activity based upon analyzing the collected surveillance information (i.e., status information 242, context information 244, and context information 246) using recognition techniques. For example, the surveillance module 228 can determine the potential occurrence of a physical confrontation between inmates 206 based on the words and/or phrases detected in the surveillance information 248 received from the inmate devices 212. As another example, the surveillance module 228 can determine that movements detected in the status information 242 (i.e., video capture) are consistent with a physical attack. In some examples, the surveillance module 228 employs machine learning techniques to identify potentially suspicious or dangerous activity. In addition, the surveillance module 228 verifies tracking information determined by the tracking module 226. For instance, the surveillance module 228 can confirm the location of the inmate 206(1) by applying facial recognition and/or voice recognition to the status information 242 received from the sensors and controllers 216.

The telemedicine module 230 analyzes the context information 244 received from the inmate devices 212. In some instances, the context information 244 includes wellness information pertaining to the inmates 206. As described herein, wellness information includes heart rate information, oxygen saturation, glucose levels, respiration rate, body temperature information, sleep patterns, posture, step count, and electrocardiography. In addition, the wellness information includes data describing medical biomarkers detected by the inmate devices 212. Further, the telemedicine module 230 monitors the wellness information for anomalies and/or medical emergency events. As described herein, a medical emergency event includes any and all indicators of a potential risk to the health of a human being. In addition, the telemedicine module 230 presents the wellness information to the facility personnel 208. For example, the telemedicine module 230 sends the wellness information to one or more facility personnel devices 214. As another example, the telemedicine module 230 displays the wellness information on one or more display monitors connected to the emergency management server 210.

Furthermore, the telemedicine module 230 determines an estimated health diagnosis based upon the context information 244. For instance, the context information 244 may include the heart rate and blood pressure of the inmate 206(1) associated with the inmate device 212(1). As a result, the telemedicine determines a plurality of potential health diagnoses in view of the heart rate and/or blood pressure. For example, if the reported heart rate is above a predetermined range, the telemedicine module 230 may estimate that the inmate 206(1) is suffering from cardiac arrest, pulmonary embolism, or septic shock. As another example, if the reported blood pressure is above a predetermined range, the telemedicine module 230 may estimate that the inmate 206(1) is suffering a cerebrovascular incident. In some instances, the predetermined range is based upon previously collected heart rate information specific to the inmate 206(1). Furthermore, in some instances, telemedicine module 230 employs machine learning techniques to identify the predetermined range and/or estimated health diagnoses.

The digital security module 232 controls access to the network 218, manages authentication of the inmate devices 212 and the facility personnel devices 214, and manages authorization of inmate device 212 activities and the facility personnel device 214 activity. Further, the digital security module 232 verifies the integrity of the inmate devices 212 and the facility personnel devices 214. For example, the digital security module 232 determines whether the firmware or operating system of an inmate device 212(1) has been compromised (e.g., jail broken). As another example, the digital security module 232 determines whether an unauthorized hardware component has been connected to the inmate device 212(1). Further, the digital security module 232 determines whether one or more required applications/features are installed and/or functional on the inmate device 212(1). For instance, the digital security module 232 verifies that the inmate device 212(1) is capable of presenting an alarm button and sending a distress message to the emergency management server 210.

Additionally, the digital security module 232 deactivates the inmate device 212(1) or prevents an inmate device 212(1) from joining the network 218 based on a failure to verify the integrity of the inmate device 212(1). Further, the digital security module 232 alerts the facility personnel 208 to the failed verification attempt of the inmate device 212(1). In some instances, the digital security module 232 initiates an upgrade to the firmware, operating system, and/applications of the inmate device 212(1) in response to a failed verification attempt.

Further, the digital security module 232 controls access to the inmate devices 212 by the inmates 206. For instance, the digital security module 232 manages an authentication process by the inmate 206(1) attempting to use the inmate device 212(1), and only permits the inmate 206(1) to access the inmate device 212(1) upon successful authentication. In some examples, the digital security module 232 relies on the inmate device 212(1) to authenticate the inmate 206. Once the inmate device 212(1) has authenticated the inmate 206(1), the inmate device 212(1) sends a notification to the digital security module 232 indicating successful authentication of the inmate 206(1). In some other examples, the digital security module 232 authenticates the inmates 206 using at least one of biometric information (e.g., fingerprint information, voice information, retinal information, facial information, wellness information, etc.), a username and password combination, challenge response, etc. For instance, the inmate device 212(1) sends authentication information to the digital security module 232, and the digital security module 232 compares the authentication information to previously stored authentication information in order to authenticate the inmate 206(1). In some cases, the previously stored authentication information is stored in the inmate profile 236(1) associated with the inmate 206(1).

Once an inmate 206 successfully completes authentication, the digital security module 232 stores an association between the inmate 206 and the inmate device 212. For instance, the digital security module 232(1) updates the inmate profile 236(1) and/or device profile 238(1) to store an association indicating that the inmate 206(1) is currently in possession of the inmate device 212(1). Furthermore, upon successful authentication of the inmate 206, the digital security module 232 permits the inmate 206(1) to access the inmate device 212(1), and allows applications on the inmate device 212(1) to access the network 218 and/or any other digital resources accessible to inmate devices 212 within the controlled environment 201. By verifying the integrity of the inmate devices 212 and authenticating the inmates 206 prior to permitting access to the network 218, the digital security module 218 ensures the security, integrity, and privacy of the network 218.

Further, the digital security module 232 manages passive authentication of the inmates 206 using the inmate devices 212 while the inmates 206 are in possession of the inmate devices 212. In some cases, continued passive authentication allows the digital security module 232 to monitor possession of the inmate devices 212 after the initial authentication process is completed. For instance, the digital security module 232 periodically receives authentication information from the inmate device 212(1), and performs an authentication process based on the authentication information. If the inmate 206(1) fails passive authentication, the digital security module 232 modifies the association between the inmate device 212(1) and the inmate 206(1) stored in the inmate profile 236(1) and/or device profile 238(1). For instance, the digital security module 232 modifies an inmate—inmate device association to indicate that the inmate 206(1) is no longer in possession of the inmate device 212(1). Further, the digital security module 232 deactivates the inmate device 212(1) and/or denies access by the inmate device 212(1) to digital resources accessible to the inmate devices 212 within the controlled environment 201. In some examples, the inmate devices 212 send the passive authentication information in the context information 244. In some other examples, the digital security module 232 samples a portion of the surveillance information 248 to obtain biometric authentication information, and uses the sample portion to passively authenticate the inmates 206.

In addition, the digital security module 232 alerts the facility personnel 208 to the failed passive authentication and potential change in possession of the inmate device 212(1). In some cases, the failed passive authentication indicates an unauthorized dispossession of the inmate device 212(1), and/or unauthorized use of the inmate device 212(1) by another one of the inmates 206(2)-206(N). Additionally, or alternatively, the digital security module 232 relies on the inmate devices 212 to passively authenticate the inmates 206. For instance, the digital security module 232 may periodically receive notifications from the inmate device 212(1) indicating that the inmate device 212(1) has passively authenticated the inmate 206(1), and thus it can be assumed the inmate 206(1) is still in possession of the inmate device 212(1). In some examples, the inmate devices 212 include the notifications in the context information 244. Additionally, or alternatively, the inmate devices 212 may include a locking functionality that prevents the inmates 206 from being dispossessed of the inmate devices 212, or removing the inmate devices 212 from their person.

Additionally, the digital security module 232 manages inmate device permissions, facility personnel device permissions, inmate permissions, and facility personnel permissions. The permissions define the rights of a device or a device user to access particular applications, files, folders, and network resources. In other words, the digital security module 232 uses the inmate device permissions and inmate permissions to authorize device activity by the inmate devices 212 and facility personnel devices 214.

For example, the inmate 206(1) is permitted to use an application on the inmate device 212(1) based at least in part on the inmate device permissions and/or the inmate permissions. In some cases, the permissions apply to individual inmates 206 and/or inmate devices 212. In some other cases, permissions apply to groups of inmates 206 or groups of inmate devices 212 within the controlled environment 201. Furthermore, the inmate permissions and inmate device permissions are stored in the inmate information 220 and the device information 222, respectively.

The emergency response module 234 receives distress messages 254(1)-254(N) from the inmate devices 212 and/or the facility personnel devices 214, and coordinates adequate and proportionate responses by the facility personnel 208 to the distress messages 254. In some cases, the emergency response module 234 utilizes the tracking module 226, the surveillance module 228, the telemedicine module 230, and/or the digital security module 232 to determine the proper response to distress messages 254.

Referring to FIG. 2, suppose a distressed inmate 250 activates an alarm button on a distressed inmate device 252. For example, the distressed inmate 250 may be experiencing dizziness and lightheadedness, and wish for medical assistance as a precaution. In response, the distressed inmate device 252 sends a distress message 254(1) to the emergency response module 234 of the emergency management server 210. In some examples, the distress message 254 includes a device identifier 256 identifying the distressed inmate device 252, and context information 258 collected by the distressed inmate device 252. Furthermore, the context information 258 includes a location identifier 260 identifying that the distressed inmate device 252 is currently located in the cell block 204, and wellness information 262 associated with the distressed inmate 250.

Upon receipt of the distress message 254(1), the emergency response module 234 may determine that the distress message 254(1) corresponds to a medical emergency event. For instance, the emergency response module 234 sends the wellness information 262 to the telemedicine module 230 for analysis. In response, the telemedicine module 230 identifies the occurrence of a potential medical emergency event based on the wellness information 262, and determines an emergency response corresponding to the potential medical emergency event. After the emergency response is determined, the emergency response module 234 sends an emergency response communication 264 notifying the facility personnel 208 of the potential medical emergency event. In some instances, the emergency response communication 264 includes instructions to the facility personnel 208 for addressing the distress message 254(1). Additionally, the emergency response module 234 may establish a communication channel between the distressed inmate device 252 and facility personnel devices 214 as described with respect to FIG. 1.

In some examples, the emergency response module 234 assigns particular facility personnel 208 to resolving the distress message 254(1). For instance, the emergency response module 234 may determine that facility personnel 208(1) is qualified to address the potential medical emergency event, and send the emergency response communication 264 to the facility personnel device 214(1). In some instances, the emergency response communication 264 also includes instructions for the other facility personnel 208(2)-208(N). For example, the emergency response module 234 may send commands to one or more facility personnel 208(2)-208(N) to monitor an area of the controlled environment 201 vacated by the facility personnel 208(1) assigned to the distress message 254(1). As another example, the emergency response module 234 may send commands to the other facility personnel 208(2)-208(N) to guard the facility personnel 208(1) assigned to the distress message 254 as the facility personnel 208(1) travels to the distressed inmate 250.

Additionally, or alternatively, the emergency response module 234 identifies specific facility personnel 208 capable of assisting the distressed inmate 250 within a specific period of time. For instance, the telemedicine module 230 may determine that the distressed inmate 250 is in need of immediate assistance due to the severity or nature of the potential medical emergency event. As such, the emergency response module 234 determines that the facility personnel 208(1) is within a predetermined distance of the distressed inmate 250 based at least in part on information from tracking module 226, and sends the emergency response communication 264 to the facility personnel device 214(1).

In addition, the emergency response module 234 determines the amount of facility personnel 208 required to address the distress message 254, and assigns no less than the determined amount of facility personnel 208 to managing the distress message 254. In some cases, the emergency response module 234 determines the amount of facility personnel 208 required to address the distress message 254 based upon the amount of inmates 206 in the vicinity of the distressed inmate 250, one or more attributes of the location of the distressed inmate 250, one or more attributes of the distressed inmate 250, and/or one or more attributes of any of the inmates 206 in the vicinity of the distressed inmate 250. For example, the emergency response module 234 assigns a greater amount of facility personnel 208 to an emergency involving an inmate 206(1) known to possess a propensity for physical confrontation. Further, the emergency response module 234 determines the amount of facility personnel 208 required to address the distress message 254 based on the inmate information 220, the surveillance module 228 and/or the tracking module 226.

Additionally, the emergency response module 234 determines a route for specific facility personnel 208 to travel to the distressed inmate 250, and sends the route to the facility personnel devices 214 within the emergency response communication 264. Given the dangers presented by inmates 206 within the controlled environment 201, the emergency response module 234 takes into consideration the safety of facility personnel 208 while traveling to the distressed inmate 250. In some instances, the emergency response module 234 recommends that the facility personnel 208 travel a longer route to the distressed inmate 250 in order to avoid confronting a large crowd of unrestrained inmates 206 and/or one or more inmates 206 known to possess a propensity for physical confrontation.

Further, the emergency response module 234 employs the control module 224 to modify the controlled environment 201 in response to the distress message 254(1) and/or the assignment of the facility personnel 208 to the distress message 254(1). For example, the emergency response can instruct the control module 224 to send a control command 240 instructing the sensors and controllers 216 to close one or more doors within the controlled environment 201 in order to increase the safety of a route to the distressed inmate 250.

Furthermore, the emergency response module 234 leverages the inmate devices 212 to increase the efficacy of the emergency response. For example, the emergency response module 234 may identify one or more inmate devices 212 within a predetermined distance of the distressed inmate device 252 using the tracking module 226 and/or surveillance module 228. Further, the emergency response module 234 employs the surveillance module 228 to activate a surveillance mode on the identified inmate devices 212. In addition, the emergency response module 234 forwards the collected surveillance information 248 from the identified inmate devices 212 to the facility personnel 208. In some other examples, the emergency response module 234 employs the digital security module 232 to deactivate or restrict the use of the identified inmate devices 212. For instance, suppose one or more inmates 206 are executing a pre-planned attack on the distressed inmate 250, the emergency response module 234 prevents the inmate devices 212 from sending messages between each other in order to prevent further coordination amongst the conspirators. As yet still another example, the emergency response module 234 sends the emergency response communication 264 to the inmate devices 212. For instance, in order to expedite the emergency response by the facility personnel 208, the emergency response module 234 may send the emergency response communication 264 to the inmate devices 212 with instructions ordering the inmates 206 to return to the cell block 204.

In some instances, the emergency response module 234 preemptively determines an emergency response based at least in part on status information 242, context information 244 received from the inmate devices 212, context information 246 received from the facility personnel devices 214, the inmate information 220, the device information 222, and/or indicators received from the control module 224, the surveillance module 228, the tracking module 226, the telemedicine module 230, or the digital security module 232. In other words, the emergency response module 234 determines an emergency response, and sends the emergency response communication 264 to the facility personnel 208 prior to receiving the distress message 254.

For example, the surveillance module 228 detects a potential medical emergency event based on the context information 244 received from the inmate devices 212. Further, the surveillance module alerts the emergency response module 234 to the potential medical emergency event. Additionally, the emergency response module 234 sends a health status request 266 to the distressed inmate device 252 inquiring about the medical status of the distressed inmate 250. In addition, the distressed inmate device 252 sends a health status response 268 in reply. In some examples, the distressed inmate device 252 sends the health status response 268 based on input received from the distressed inmate 250. For instance, the distressed inmate 250 may confirm the occurrence of a medical event via a graphical user interface of the distressed inmate device 252. If the health status response 268 indicates that the distressed inmate is in need of medical attention, the emergency response module 234 determines an emergency response and sends the emergency response communication 264 to the facility personnel devices 214. In some other examples, the emergency response module 234 receives the alert from the surveillance module 228, immediately determines an emergency response, and sends the emergency response communication 264 to the facility personnel devices 214.

As another example, the telemedicine module 230 may indicate to the emergency response module 234 that the distressed inmate 250 is experiencing a heightened heart rate. In response, the emergency response module 234 can check the inmate information 220 associated with the distressed inmate 250 to determine if the distressed inmate 250 is expected to have a heightened heart rate at this time. For instance, the profile information 220 may include a daily schedule of the distressed inmate 250, and/or historic daily heart rate values of the distressed inmate 250. Consequently, the emergency response module 234 determines whether the heightened heart rate is abnormal in view of the distressed inmate's 250 daily schedule and historic daily heart rate. If the heightened heart rate is abnormal, the emergency response module 234 sends the health status request 266 to the distressed inmate device 252 and/or determines an emergency response.

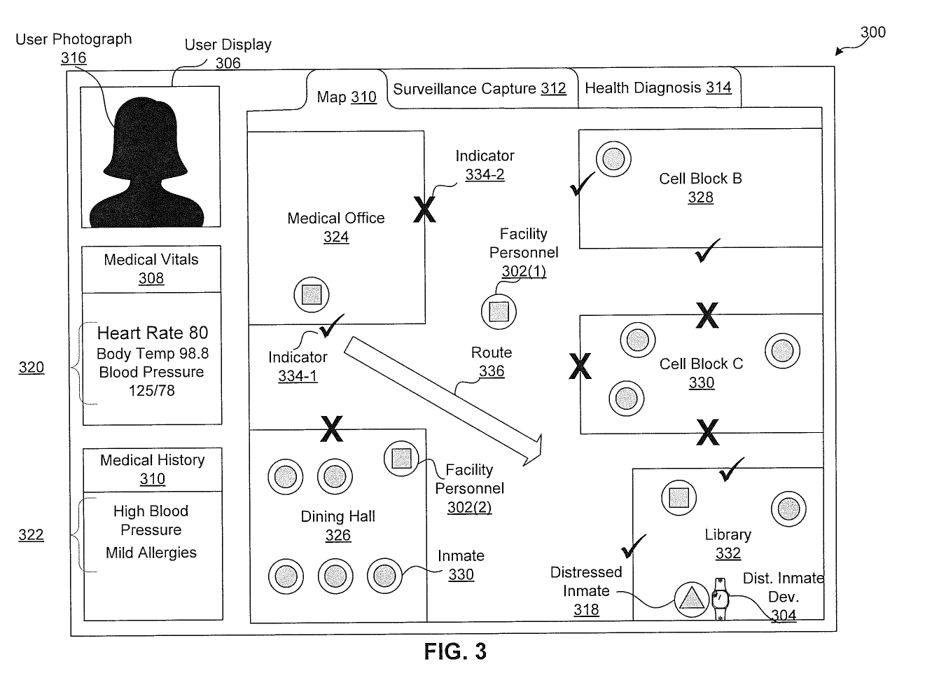

FIG. 3 illustrates an example graphical user interface 300 presented to facility personnel 302 in response to a distress message (e.g., distress message 254) received from a distressed inmate device 304 within the controlled environment (e.g., controlled environment 201).

Suppose the emergency management server 210 (not shown in FIG. 2) receives the distress message from the distressed inmate device 304. In response, the emergency response module 234 generates the graphical user interface 300. Further, the emergency response module 234 presents the graphical user interface 300 to the facility personnel 302. The graphical user interface 300 includes a user display section 306, a medical vitals section 308, medical history section 310, a controlled environment map 312, a surveillance capture section 312, and a health diagnoses section 314.

The user display section 306 displays a photograph 316 of a distressed inmate 318 associated with the distressed inmate device 304. In some cases, the facility personnel 302 are able to use the photograph 316 to identify the distressed inmate 318 upon arrival at the location of the distressed inmate device 304. The photograph 316 of the distressed inmate 318 is based on one or more images contained in the inmate information (e.g., inmate profile 236) corresponding to the distressed inmate 318.

As illustrated in FIG. 3, the medical vitals section 308 displays wellness information 320 associated with the distressed inmate (e.g., heart rate, body temperature, respiration rate, blood pressure, etc.). The wellness information 320 is captured by the distressed inmate device 304, sensors and controllers (e.g., sensors and controllers 216), and/or other devices within the controlled environment. The medical vitals section 308 permits the facility personnel 302 to monitor and/or detect potential medical problems facing the distressed inmate 318. In some instances, the wellness information 320 is displayed with graphical effects in order to communicate an abnormal or normal status. Some examples of graphical effects include a graphic scheme, color scheme (e.g., brightness intensity lightness, darkness), or graphic element. As shown in FIG. 3, the heart rate is represented in a larger font size to represent that the distressed inmate's 318 heart rate is abnormally high.

The medical history section 310 displays the medical history 322 of the distressed inmate 318 associated with the distressed inmate device 252. As illustrated in FIG. 3, the medical history describes previous medical incidents and current medical illnesses associated with the distressed inmate 318. In some examples, the medical history 322 of the distressed inmate 318 is based on medical information included in the inmate information (e.g., such as inmate profile 236) corresponding to the distressed inmate 318. Additionally, or alternatively, the medical information is retrieved from a remote database of medical information.

The controlled environment map 312 displays a graphical representation of at least a portion of the controlled environment. As shown in FIG. 3, the controlled environment map 312 demarcates an area for a medical office 324, an area for a dining hall 326, an area for a cell block B 328, an area for a cell block C 330, and a library 332. Further, the controlled environment map 312 includes indicators 334 representing the status of doorways within the controlled environment. As illustrated in FIG. 3, a checkmark 334(1) signifies that a doorway is currently open or unlocked, and an ‘X’ 334-2 signifies that a doorway is currently closed and locked.

Additionally, the controlled environment map 312 displays inmates 336 and facility personnel 302 located within the controlled environment. In some examples, the emergency response module 234 employs the tracking module 226 and/or surveillance module 228 to determine the location of the inmates 336 and facility personnel 302 represented on the controlled environment map 312. In some cases, the controlled environment map 312 uses graphical effects to distinguish between the inmates 336, the distressed inmate 318, and the facility personnel 302. As shown in FIG. 3, the distressed inmate 318 is represented by a filled triangle surrounded by a circle. Further, the other inmates 334 are represented by a filled circle surrounded by an unfilled circle. In addition, the facility personnel 302 are represented by a filled square surrounded by a circle. Although FIG. 3 illustrates the aforementioned representations, the representations can be implemented according to any combination of shape, style, color, etc.

Furthermore, the representations of the distressed inmate 318, the inmates 336, and the facility personnel 302 are selectable via the graphical user interface 300. In some examples, the graphical user interface 300 further provides functionality for displaying additional information about the inmate or facility personnel associated with a selected representation, sending commands to a device associated with the selected representation, and/or communicating with the device associated with the selected representation.

As shown in FIG. 3, the controlled environment map 312 further illustrates a route 338 for traveling from a location within the controlled environment to the distressed inmate 318. As described herein, the emergency response module 234 determines the route based at least in part on the tracking module 226 and/or the surveillance module 228. As illustrated in FIG. 3, the route 338 recommends the facility personnel 302 travel a direct route to the distressed inmate 318. Further, the route 318 avoids traveling through portions of the controlled environment with open doors, and recommends the facility personnel 302 travel through portions of the controlled environment patrolled by other facility personnel 302.

The surveillance capture section 312 is selectable by the facility personnel 302 viewing the graphical interface 300. The surveillance capture section 312 displays audio information or video information pertaining to distressed inmate 318. For example, the surveillance capture section 312 displays an audio-visual stream from the distressed inmate device 304, an inmate device in the vicinity of the distressed inmate 318, and/or a surveillance camera (e.g., sensors and controllers 216) in the vicinity of the distressed inmate 318. Further, the surveillance capture section 312 includes functionality for communicating with the distressed inmate 318 via the distressed inmate device 304. Therefore, the facility personnel 302 are provided an opportunity to suggest first aid recommendations to the distressed inmate 318 and/or determine the validity of the emergency.

The health diagnoses section 314 is selectable by the facility personnel 302 viewing the graphical interface 300. Further, the health diagnoses section 314 presents one or more estimated health diagnoses associated with the distress message. As described herein, the telemedicine module 230 determines the estimated health diagnosis based on context information received from the distressed inmate device 304, the distressed inmate's 318 medical history, the sensors and controllers, and other devices within the controlled environment.

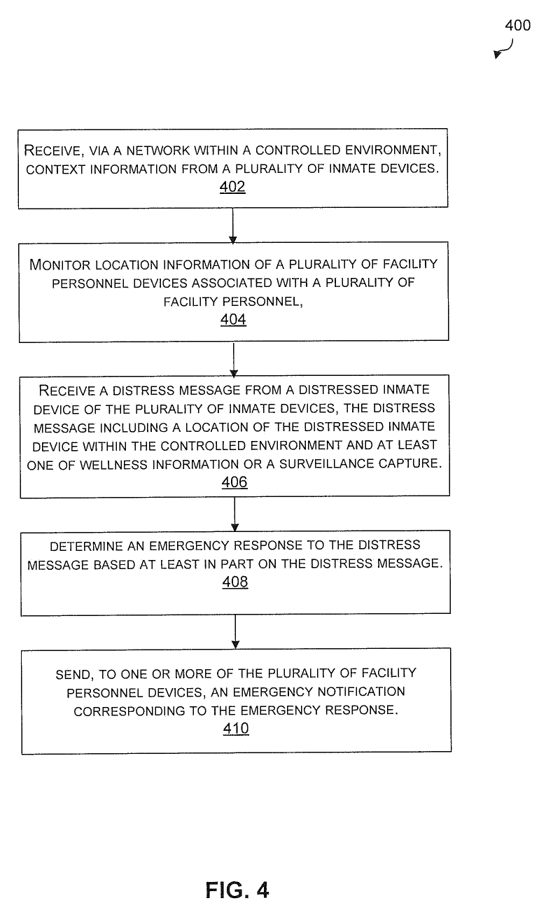

FIG. 4 illustrates a process 400 for providing an emergency response within a controlled environment according to some implementations. The process 400 is illustrated as a collection of blocks in a logical flow graph, which represent a sequence of operations that can be implemented in hardware, software, or a combination thereof. The blocks are referenced by numbers 402-410. In the context of software, the blocks represent computer-executable instructions stored on one or more computer-readable media that, when executed by one or more processing units (such as hardware microprocessors), perform the recited operations. Generally, computer-executable instructions include routines, programs, objects, components, data structures, and the like that perform particular functions or implement particular abstract data types. The order in which the operations is described is not intended to be construed as a limitation, and any number of the described blocks can be combined in any order and/or in parallel to implement the process.

At 402, an emergency management server receives, via a network within a controlled environment, context information from a plurality of inmate devices. For example, the emergency management server 210 receives the context information 244 from the plurality of inmate devices 212. In some examples, the context information 244 includes sensor data (e.g., location/gps information, accelerometer data, gyroscope data, compass data, photometer data, magnetometer data, thermometer data, proximity sensor data, etc.) collected by sensors of the inmate devices 212. In addition, the context information 244 includes authentication information, and/or device activity information. For instance, the context information 244 includes information notifying the emergency management server 210 of a successful passive authentication of the inmate 206(1) by the inmate device 212(1). In another instance, the context information 244 notifies the emergency management server 210 of application usage of the inmate device 212(1) or a device status (e.g., battery status, battery health, network connectivity, device settings, device configuration, etc.) of an inmate device 212. In yet another instance, the context information 244 includes audio data or video data captured by an inmate device 212. For example, the context information 244 includes audio captured by a microphone of the inmate device 212(1).

Further, in some examples, the type of context information received from each inmate device 212 differs depending upon the capabilities of the source inmate device 212. For instance, the inmate device 212(1) may not include a magnetometer, and thus be unable to communicate the presence of metal in proximity to the inmate device 212(1).

At 404, the emergency management server monitors location information of a plurality of facility personnel devices associated with a plurality of facility personnel, individual facility personnel devices associated with individual facility personnel. For example, the emergency management server 210 receives context information 246 from the facility personnel devices 214. As described herein, the context information 244 includes the location of individual facility personnel devices 214 within the controlled environment 201.

At 406, the emergency management server receives a distress message from a distressed inmate device of the plurality of inmate devices, the distress message including a location of the distressed inmate device within the controlled environment and at least one of wellness information or a surveillance capture. For instance, the distressed inmate 250 may be attacked by another inmate 212(1) within the cell block 204, and press an alarm button on the distressed inmate device 252. As a result, the distressed inmate device 252 sends the distress message 254 to the emergency management server 210. In some examples, the distress message 254 includes the context information 258. For instance, the distress message 254 includes a current location of the distressed inmate device 252, wellness information 262 corresponding to the distressed inmate 250, or sensor information captured by sensors of the distressed inmate device 252. Furthermore, in some instances, the distress message 254 indicates whether the distressed inmate 250 is experiencing a medical emergency or personal safety emergency. For example, the distressed inmate 250 may press an alarm button corresponding to a physical confrontation given that the distressed inmate 250 is under attack. Consequently, the distress message 254 indicates that the distress message 254 is associated with a physical confrontation.

At 408, the emergency management server determines an emergency response to the distress message based at least in part on the distress message. For example, the emergency server module 210 provides the distress message 254 to the emergency response module 234, which determines an emergency response with respect to the distress message 254. Further, the emergency response module 234 determines the emergency response based on the context information 258 included in the distress message 254, the context information 244 received from the inmate devices 212, the context information 246 received from facility personnel devices 214, and/or information received from at least one of the control module 224, the surveillance module 228, the tracking module 226, the telemedicine module 230, or the digital security module 232.

For instance, the emergency response module 234 relies on information from the tracking module 226 and/or the surveillance module 228 to determine a plurality of inmates within a predetermined distance of the distressed inmate 250 in the cell block 204. Additionally, or alternatively, the emergency response module 234 determines a plurality of inmates 206 involved in the physical incident based at least in part on context information 244 from the inmate devices 212. For example, the respective heart rates of the plurality of inmates 206 might spike during the physical incident, or the accelerometers of the inmate devices 212 associated with the inmates 206 involved in the physical incident might capture sensor readings indicative of combat. Further, the emergency response module 234 determines an amount of facility personnel 208 to assign to restoring peaceful order within the cell block 204 in view of the plurality of inmates 206 within a predetermined distance of the distressed inmate 250 and/or the plurality of inmates 206 involved in the physical incident. Once the emergency response module 234 has determined the amount of facility personnel 208 to assign to the distress message 254, the emergency response module 234 selects facility personnel 208 to assign to the distress message 254.

In another instance, the emergency response module 234 relies on information from the telemedicine module 230 to determine a type of facility personnel 208 to assign to a distress message 254. For example, the distress message 254 includes wellness information 262 indicating the blood pressure of the distressed inmate 250, and the telemedicine module 230 determines that there is a reasonable likelihood the distressed inmate 250 is experiencing blood loss due to the physical incident based on the blood pressure reading. For instance, the distressed inmate's 250 blood pressure may have severely dropped within a predetermined time span. Consequently, the emergency response module 234 assigns facility personnel 208 with a first aid background to the distress message 254 in order to provide the distressed inmate 250 with appropriate medical attention. In addition, the telemedicine module 230 recommends a response time to the emergency response module 234 based on the wellness information 262. For instance, the telemedicine module 230 may determine that distressed inmate 250 requires medical attention within two minutes to avoid a negative long term health outcome.

In yet another instance, the emergency response module 234 relies on information from the control module 224, tracking module 226, and/or surveillance module 228 to determine a route for facility personnel 208 to travel to the distressed inmate 250. For example, the emergency response module 234 may assign a particular facility personnel 208(1) to the distress message 254. Further, the emergency response module 234 determines potential travel routes from the location of the particular facility personnel 208(1) to the distressed inmate 250. The potential travel routes are determined in accordance with well-known mapping techniques. Additionally, the emergency response module 234 evaluates the potential routes in view of safety and/or temporal attributes.

For example, one of the potential routes may require that particular facility personnel travel in proximity to a dining hall of the controlled environment. Further, the tracking module 226 may indicate the presence of a significant amount of inmates 206 in the dining hall, and the control module 224 may indicate that the doors to the dining hall are open. Consequently, the emergency response module 234 determines that there is a safety risk associated with traveling the potential travel route. As a result, the emergency response module 234 may not recommend the potential route to the particular facility personnel 208(1) based at least in part on the safety risk.

At 410, the emergency management server sends, to one or more of the plurality of facility personnel devices, an emergency notification corresponding to the emergency response. For example, the emergency response module 234 sends emergency response communication 264 (e.g., medical alert, emergency alert, etc.) to the facility personnel devices 214. Further, the emergency response communication 264 includes details corresponding to the distress message 254, and instructions for addressing the distress message 254. For instance, the emergency response communication 264 identifies the distressed inmate 250, indicates that the emergency is related to a physical incident, and identifies specific facility personnel 208 assigned to the distress message 254. In some examples, the emergency response communication 264 further includes a travel route from a location of the facility personnel 208 to the location of the distressed inmate 250. In some other examples, the commands include an estimated health diagnosis associated with the distress message 254.

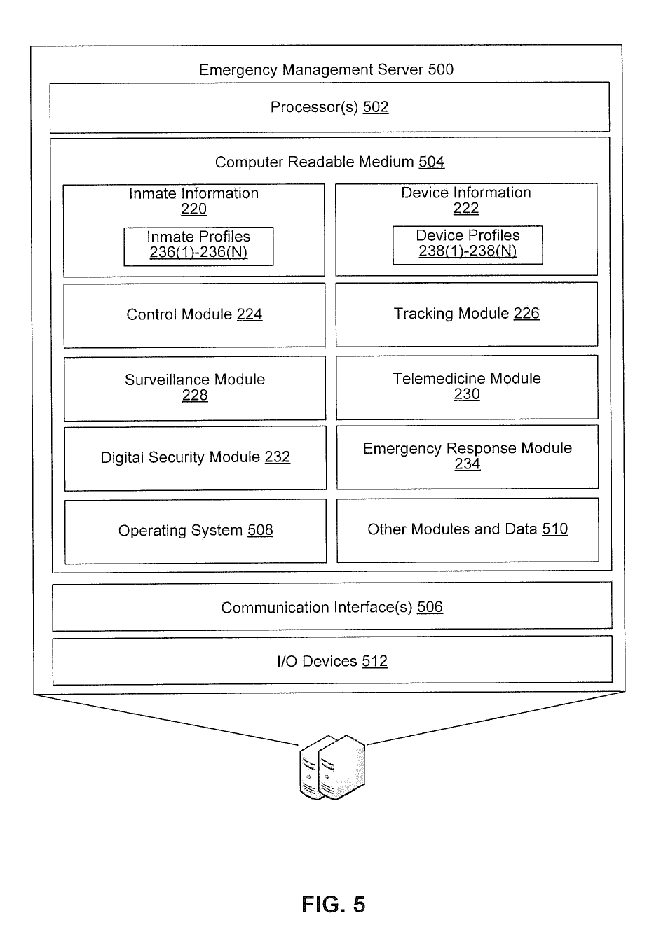

FIG. 5 illustrates select components of the emergency management server 500. The emergency management server 210 includes one or more servers or other types of computing devices that may be embodied in any number of ways. For instance, the modules, other functional components, and data may be implemented on a single server, a cluster of servers, a server farm or data center, a cloud-hosted computing service, and so forth, although other computer architectures may additionally or alternatively be used.

Further, while the figures illustrate the components and data of the emergency management server 500 as being present in a single location, these components and data may alternatively be distributed across different computing devices and different locations in any manner. Consequently, the functions may be implemented by one or more computing devices, with the various functionality described above distributed in various ways across the different computing devices. Multiple emergency management servers 500 may be located together or separately, and organized, for example, as virtual servers, server banks and/or server farms. The described functionality may be provided by the servers of a single entity or enterprise, or may be provided by the servers and/or services of multiple different entities or enterprises.

In the illustrated example, the emergency management server 500 includes one or more processors 502, one or more computer-readable media 504, and one or more communication interfaces 506. Each processor 502 is a single processing unit or a number of processing units, and may include single or multiple computing units or multiple processing cores. The processor(s) 502 can be implemented as one or more microprocessors, microcomputers, microcontrollers, digital signal processors, central processing units, state machines, logic circuitries, and/or any devices that manipulate signals based on operational instructions. For instance, the processor(s) 502 may be one or more hardware processors and/or logic circuits of any suitable type specifically programmed or configured to execute the algorithms and processes described herein. The processor(s) 502 can be configured to fetch and execute computer-readable instructions stored in the computer-readable media 504, which can program the processor(s) 502 to perform the functions described herein.

The computer-readable media 504 include volatile and nonvolatile memory and/or removable and non-removable media implemented in any type of technology for storage of information, such as computer-readable instructions, data structures, program modules, or other data. Such computer-readable media 504 include, but are not limited to, RAM, ROM, EEPROM, flash memory or other memory technology, optical storage, solid state storage, magnetic tape, magnetic disk storage, network attached storage, storage area networks, cloud storage, or any other medium that can be used to store the desired information and that can be accessed by a computing device. Depending on the configuration of the emergency management server 500, the computer-readable media 504 may be a type of computer-readable storage media and/or may be a tangible non-transitory media to the extent that when mentioned, non-transitory computer-readable media exclude media such as energy, carrier signals, electromagnetic waves, and signals per se.

The computer-readable media 504 is used to store any number of functional components that are executable by the processors 502. In many implementations, these functional components comprise instructions or programs that are executable by the processors and that, when executed, specifically configure the one or more processors 502 to perform the actions attributed above to the emergency management server 500. In addition, the computer-readable media 504 store data used for performing the operations described herein.

In the illustrated example, the functional components stored in the computer-readable media 504 include the control module 224, the tracking module 226, a surveillance module 228, the telemedicine module 230, the digital security module 232, and the emergency response module 234. Further, the computer-readable media store the inmate information 220 and the device information 222.

Additional functional components stored in the computer-readable media 504 include an operating system 508 for controlling and managing various functions of the emergency management server 500. The emergency management server 500 also include or maintain other functional components and data, such as other modules and data 510, which include programs, drivers, etc., and the data used or generated by the functional components. Further, the emergency management server 500 includes many other logical, programmatic and physical components, of which those described above are merely examples that are related to the discussion herein.

The communication interface(s) 506 include one or more interfaces and hardware components for enabling communication with various other devices, such as the inmate device(s) 212, the facility personnel device(s) 214 or other computing devices, over the network(s) 218. For example, communication interface(s) 506 facilitate communication through one or more of the Internet, cable networks, cellular networks, wireless networks (e.g., Wi-Fi, cellular) and wired networks. As several examples, the emergency management server 500 and the inmate devices 212 communicate and interact with one another using any combination of suitable communication and networking protocols, such as Internet protocol (IP), transmission control protocol (TCP), hypertext transfer protocol (HTTP), cellular or radio communication protocols, and so forth. Examples of communication interface(s) include a modem, a network interface (such as an Ethernet card), a communications port, a PCMCIA slot and card, etc.

The emergency management server 500 may further be equipped with various input/output (I/O) devices 512. Such I/O devices include a display, various user interface controls (e.g., buttons, joystick, keyboard, mouse, touch screen, etc.), audio speakers, connection ports and so forth.

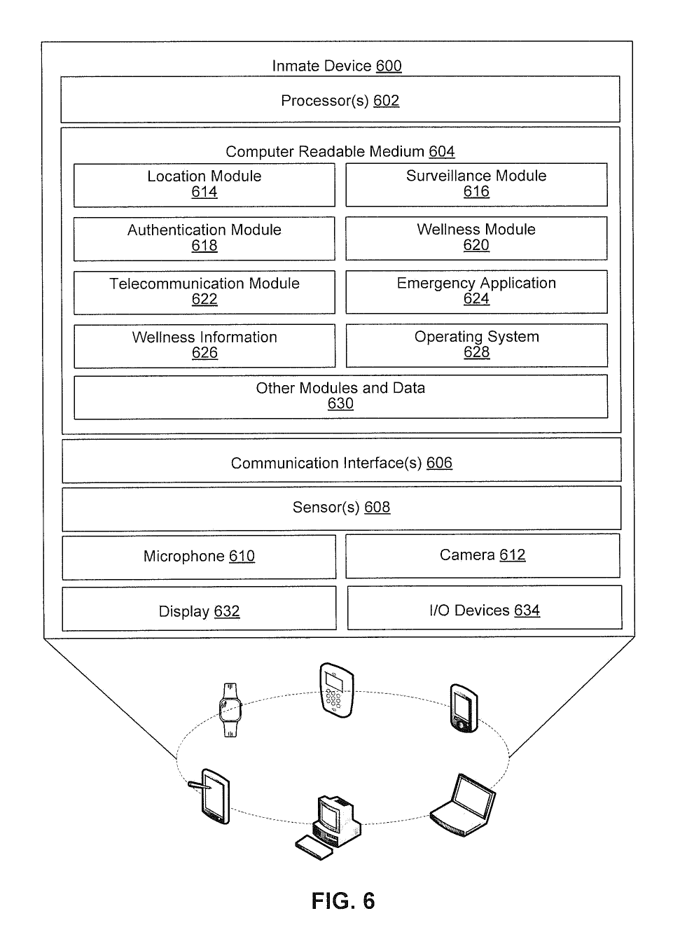

FIG. 6 illustrates select example components of the inmate device 600, such as the inmate devices 212 and the distressed inmate device 252, that implement the functionality described above according to some examples. The inmate device 600 may be any of a number of different types of personal computing devices. Some examples of the inmate device 600 include wearable computing devices, smart phones and mobile communication devices; tablet computing devices; desktops, laptops, netbooks and other portable computers, and any other portable device capable of sending communications and performing the functions according to the techniques described herein.

In the illustrated example, the inmate device 600 includes one or more processors 602, one or more computer-readable media 604, one or more communication interfaces 606, one or more sensors 608, a microphone 610, and a camera 612. Each processor 602 is a single processing unit or a number of processing units, and may include single or multiple computing units or multiple processing cores. The processor(s) 602 can be implemented as one or more microprocessors, microcomputers, microcontrollers, digital signal processors, central processing units, state machines, logic circuitries, and/or any devices that manipulate signals based on operational instructions. For instance, the processor(s) 602 may be one or more hardware processors and/or logic circuits of any suitable type specifically programmed or configured to execute the algorithms and processes described herein. The processor(s) 602 can be configured to fetch and execute computer-readable instructions stored in the computer-readable media 604, which can program the processor(s) 602 to perform the functions described herein.

The computer-readable media 604 include volatile and nonvolatile memory and/or removable and non-removable media implemented in any type of technology for storage of information, such as computer-readable instructions, data structures, program modules, or other data. Such computer-readable media 604 include, but are not limited to, RAM, ROM, EEPROM, flash memory or other memory technology, optical storage, solid state storage, magnetic tape, magnetic disk storage, network attached storage, storage area networks, cloud storage, or any other medium that can be used to store the desired information and that can be accessed by a computing device. Depending on the configuration of the inmate device 600, the computer-readable media 604 may be a type of computer-readable storage media and/or may be a tangible non-transitory media to the extent that when mentioned, non-transitory computer-readable media exclude media such as energy, carrier signals, electromagnetic waves, and signals per se.

The computer-readable media 604 is used to store any number of functional components that are executable by the processors 602. In many implementations, these functional components comprise instructions or programs that are executable by the processors and that, when executed, specifically configure the one or more processors 602 to perform the actions attributed above to the inmate devices 214 and the distressed inmate device 254. In addition, the computer-readable media 604 store data used for performing the operations described herein.

In the illustrated example, the functional components stored in the computer-readable media 604 include a location module 614, a surveillance module 616, an authentication module 618, a wellness module 620, a telecommunication module 622, and an emergency application 624. Further, the computer-readable media store wellness information 626.

The location module 614 provides location functionality that allows the inmate device 600 to determine location-related information representing a location of the inmate device 600. For example, the location module 614 determines that the inmate device 600 is located in the cell block 204, and determines that location identifier 260 is associated with the cell block 204. As a result, the inmate device 600 then includes the location identifier 260 in the context information 244, or the distress message 254. In some examples, the location module 614 includes a GPS module and/or an indoor positioning system (IPS). Further, the location module 614 may rely on the sensors 608 to determine the position and motion of the inmate device 600.

The surveillance module 616 provides a surveillance mode that can be remotely activated or deactivated by a device with administrative capabilities, such as the emergency management server 210 or the facility personnel devices 214. When the surveillance mode is activated, the surveillance module 616 captures audio data, video data, keylogging information and/or click-stream information associated with the inmate device 600. For example, the emergency management server 210 requests that the inmate device 600 send the surveillance information 248 to the emergency management server 210. In some cases, the request specifies one or more types of surveillance information 248 (e.g., audio data, video data, keylogging information, click-stream information, etc.) to transmit. Upon receiving the request for the surveillance information 248, the inmate device 600 utilizes one or more components of the inmate device 600 to capture the surveillance information 248. For instance, the inmate device 600 uses the microphone 610 to capture ambient sounds from the surrounding physical environment based on the request received from the emergency management server 210. Conversely, the surveillance mode is activated locally through input (e.g., a gesture or command) to the inmate device 600. In some examples, the surveillance module 616 can operate in the background without providing any indication to the inmates 206 in the vicinity of the inmate device 600 that the surveillance mode has been activated.

The authentication module 618 authenticates an inmate in possession of the inmate device 600. The authentication module 618 employs at least one of username/password combination, voice signatures, fingerprints, retinal or iris information, and facial information to verify the identity of the inmate in possession of the inmate device 600. Further, the inmate device 600 sends authentication information associated with an authentication attempt to the emergency management server 210. For example, the inmate device 600 sends the authentication information to the emergency management device 210 in context information 244. As another example, the inmate device 600 sends the authentication information to the emergency management device 210 in the distress message 254. In some instances, the authentication information includes the authentication result, the type of information used to perform authentication, a device identifier, a location identifier, an inmate identifier, and/or the time and date of the authentication attempt. Further, in some instances, the authentication module 618 passively authenticates an inmate while the inmate device 600 is in use.

Additionally, and alternatively, the authentication module 618 collects authentication information and sends the collected authentication information to the emergency management device 210. In some examples, the authentication information further includes at least one of username/password combination, voice signatures, fingerprints, retinal or iris information, and/or facial information captured by at least one of the sensors 608, the microphone 610, and/or the camera 612. In some cases, the inmate device 600 sends the authentication information to the emergency management device 210 in the context information 244 or the surveillance information 248. In some other cases, the inmate device sends the authentication information to the emergency management device 210 in the distress message 254. Upon receipt of the authentication information, the emergency management device 210 verifies the authentication information using the inmate information 222 and/or profile information 236 associated with an inmate.

For instance, the authentication module sends biometric information captured by the inmate device 600 to the emergency management server 210. In addition, the authentication module receives an authentication result from the emergency management server 210. If the inmate is successfully authenticated, the inmate device 600 provides additional features and functionality to authenticated inmate. Further, in some instances, the authentication module 618 passively collects authentication information and sends the collected authentication information to the emergency management device 210 for verification.

The wellness module 620 manages the wellness information 626. As an example, the wellness module 620 administers the collection of heart rate information, oxygen saturation information, glucose levels, respiration rate, body temperature information, sleep patterns, posture, step count, and/or electrocardiography for an inmate associated with the inmate device 600. In some examples, the wellness module 620 directs the sensors to 608 to capture the wellness information 626. Further, the wellness module 620 analyzes the wellness information 626, and/or presents graphical representations of the wellness information 626. In addition, the inmate device 600 sends the wellness information 626 to the emergency management server 210. For example, the inmate device 600 sends the wellness information 626 to the emergency management device 210 in the context information 244. As another example, the inmate device 600 sends the wellness information 626 to the emergency management device 210 in the distress message 254.

The telecommunication module 622 is used to conduct audio and/or visual communications between the inmate devices 212, the facility devices 214, and/or the emergency management server 210. For example, the telecommunication module 622 is used to establish a two-way communication channel as described in FIG. 1. Further, the telecommunication module 622 employs the microphone 610 and camera 612 to provide the audio and/or visual data for the communications between the inmate devices 212, facility devices 214, and/or the emergency management server 210.

The emergency application 624 presents an alarm button interface, such as alarm button 108, on the inmate device 600. Further, the emergency application 624 sends the distress message 254 to the emergency management server 210 in response to an inmate activating the alarm button interface. For instance, the emergency application 624 collects the context information 244 from the location module 614 and the wellness module 620, and sends the context information 244 to the emergency management server 210 in the distress message 254. In some cases, the emergency application 624 presents an interface that allows the inmate to provide additional information about the emergency. For instance, the emergency application 624 allows an inmate to specify that the inmate requires immediate medical assistance. Additionally, the emergency application 624 receives health status queries (e.g., health status queries 266) from the emergency management device 210, and sends health status replies (e.g., health status reply 268) to the emergency management device 210 as described in FIG. 2.

Additional functional components stored in the computer-readable media 604 include an operating system 628 for controlling and managing various functions of the inmate device 600. The inmate device 600 also includes or maintains other functional components and data, such as other modules and data 630, which include programs, drivers, etc., and the data used or generated by the functional components. Further, the inmate device 600 includes many other logical, programmatic and physical components, of which those described above are merely examples that are related to the discussion herein.

The communication interface(s) 606 includes one or more interfaces and hardware components for enabling communication with various other devices, such as the emergency management server 210, facility personnel device(s) 214, or other computing devices, over the network(s) 218. For example, communication interface(s) 606 facilitates communication through one or more of the Internet, cable networks, cellular networks, wireless networks (e.g., Wi-Fi, cellular) and wired networks. As several examples, the emergency management server 210 and the inmate device 600 communicates and interacts with one another using any combination of suitable communication and networking protocols, such as Internet protocol (IP), transmission control protocol (TCP), hypertext transfer protocol (HTTP), cellular or radio communication protocols, and so forth. Examples of communication interface(s) include a modem, a network interface (such as an Ethernet card), a communications port, a PCMCIA slot and card, etc.

Some examples of the sensors 608 include an accelerometer, an ambient light sensor, a gyroscope, a compass, a light sensor, one or more localization sensors (e.g., GPS receiver), optical sensors, a photometer, a magnetometer, a stethoscope microphone, a thermometer, a thermal sensor, a proximity sensor, and any other sensor capable of capturing wellness information as described herein.

FIG. 6 further illustrates that the inmate device 600 includes a display 632. Depending on the type of computing device used as the inmate device 600, the display 632 may employ any suitable display technology. For example, the display 632 may be a liquid crystal display, a light emitting diode display, or any other suitable type of display able to present digital content thereon. In some examples, the display 632 includes touch sensor with the display 632 to provide a touchscreen display configured to receive touch inputs for enabling interaction with a graphic interface presented on the display 632. Accordingly, implementations herein are not limited to any particular display technology. Alternatively, in some examples, the inmate device 600 may not include a display 632.

Furthermore, the inmate device 600 is equipped with various input/output (I/O) devices 634. Such I/O devices 634 include a display, various user interface controls (e.g., buttons, joystick, keyboard, mouse, touch screen, etc.), audio speakers, connection ports and so forth. Additionally, the inmate device 600 includes various other components that are not shown, examples of which include removable storage, a power source, such as a battery and power control unit, and so forth.

1. An emergency alert system, comprising:
a user device associated with a user, the user located within a controlled environment;
a facility personnel device;
a secure private network;
an emergency management server that communicates with the user device via the secure private network, the emergency management server including:
one or more processors and/or circuits configured to:
store an association between the user and the user device;
receive, from the user device, a distress message including a location of the user device within the controlled environment;
determine a device identifier associated with the user device based on the distress message;
determine an identity of the user associated with the user device based at least in part on the association and the device identifier; and
send, via the secure private network, an emergency alert to the facility personnel device, the emergency alert indicating the location of the user device and the identity of the user.

2. The emergency alert system of claim 1, wherein the one or more processors and/or circuits are further configured to receive, from the user device via the secure private network, at least one of audio data or video data captured by the user device at the location.

3. The emergency alert system of claim 2, wherein the emergency management server further includes biometric information associated with the user, and the one or more processors and/or circuits are further configured to:
determine a biometric sample from the at least one of the audio data or video data; and
authenticate the user based at least in part on comparing the biometric sample to the biometric information associated with the user.

4. The emergency alert system of claim 1, wherein the user device further includes a wellness module that determines wellness information associated with the user, the distress message further includes a sample of the wellness information, and the one or more processors and/or circuits are further configured to determine an estimated health diagnosis based on the sample of wellness information.

5. The emergency alert system of claim 4, further comprising a medical personnel device associated with medical personnel within the controlled environment, and wherein the one or more processors and/or circuits are further configured to:
determine that the medical personnel is associated with the location of the user device and the estimated health diagnosis; and
send, via the secure private network, a medical alert to the medical personnel device associated with the medical personnel, the medical alert indicating the location of the user device, the identity of the user, and the estimated health diagnosis.

6. The emergency alert system of claim 4, wherein the wellness information includes at least one of heart rate information, oxygen information, and body temperature information.

7. The emergency alert system of claim 1, wherein the user device is a first user device, the emergency alert system further comprises a second user device, and the one or more processors and/or circuits are further configured to:
determine that the second user device is within a predetermined distance of the first user device; and
disable one or more device functions of the second user device.

8. The emergency alert system of claim 1, wherein the user device is a first device, the emergency alert system further comprises a second user device, and the one or more processors and/or circuits are further configured to:
determine that the second user device is within a predetermined distance of the first user device;
request surveillance information from the second user device; and
receive at least one of audio data or video data captured by the second user device.

9. The emergency alert system of claim 1, wherein the user device is a first user device, the facility personnel device is a first facility personnel device, and the emergency alert system further comprises:
a second user device; and
a second facility personnel device, and
wherein the one or more processors and/or circuits are further configured to:
monitor location information of the second user device and the second facility personnel device;
assign a particular facility personnel to the distress message based on the location information, the particular facility personnel associated with the first personnel device.

10. The emergency alert system of claim 9, wherein the location of the first user device is a first location, and the one or more processors and/or circuits are further configured to:
determine a second location of the first facility personnel device; and
determine a route from the second location of the facility personnel device to the first location of the first user device, the route determined based at least in part on the location information.

11. A method comprising:
receiving, via a secure private network within a controlled environment, context information from a plurality of inmate devices, the context information including location information of the plurality of inmate devices;
monitoring location information of a plurality of facility personnel devices associated with a plurality of facility personnel, the plurality of facility personnel devices being associated with corresponding facility personnel;
receiving a distress message from a distressed inmate device of the plurality of inmate devices, the distress message including a location of the distressed inmate device within the controlled environment and at least one of wellness information or a surveillance capture;
determining an emergency response to the distress message based on at least one of the distress message, the context information, or the location information of the plurality of facility personnel devices; and
sending, to one or more of the plurality of facility personnel devices, an emergency notification corresponding to the emergency response.

12. The method of claim 11, wherein the determining an emergency response to the distress message based at least in part on the distress message, further comprises:
identifying a medical emergency event related to an inmate associated with the distressed inmate device;
determining an estimated health diagnosis based on the wellness information;
identifying medical personnel associated with the location of the distressed inmate device and the estimated health diagnosis; and
wherein the sending of the emergency notification includes sending the emergency notification to a facility personnel device associated with the medical personnel.

13. The method of claim 11, wherein the plurality of facility personnel are a first plurality of facility personnel, the plurality of facility personnel devices are a first plurality of facility personnel devices, and determining an emergency response to the distress message based at least in part on the distress message, further comprises:
determining an emergency event related to an inmate associated with the distressed inmate device based on the surveillance capture or the wellness information;
determining an amount of facility personnel needed to address the emergency event based at least in part on one of the distress message or context information;
selecting a second plurality of facility personnel that is no less than the amount of facility personnel needed to address the emergency event; and
wherein the sending the emergency notification includes sending the emergency notification to a second plurality of facility personnel devices associated with the second plurality of facility personnel.

14. The method of claim 13, wherein the plurality of inmate devices comprise a first plurality of inmate devices, and further comprising:
determining a second plurality of inmate devices within a predetermined distance of the location of the distressed inmate device;
requesting the second plurality of inmate devices deliver surveillance information corresponding to the location of the distressed inmate device; and
receiving surveillance information from the second plurality of inmate devices.

15. The method of claim 11, wherein the location of the distressed inmate device is a first location, and further comprising:
determine a route from a second location of the one or more of the plurality of facility personnel devices to the first location of the distressed inmate device, the route determined based at least in part on estimating a travel time of the route or a safety attribute of the route.

16. A device, comprising:
one or more processors and/or circuits configured to:
store an association between an inmate and an inmate device;
receive, via the communication interface, wellness information from the inmate device;
periodically receive passive authentication information from the inmate device via the communication interface, the passive authentication information including biometric information captured by the inmate device;
determine that the passive authentication information is associated with the inmate;
determine a potential medical emergency related to the inmate based at least in part on the wellness information;
determine a location of the inmate device within a controlled environment;
determine medical personnel associated with the location of the inmate device; and
send, via the communication interface, emergency response information to a medical personnel device associated with the medical personnel, the emergency response information including the wellness information and the location of the inmate device.

17. The device of claim 16, wherein the one or more processors and/or circuits are further configured to:
determine a surveillance device associated with the location of the inmate device;
send, via the communication interface, a request to the surveillance device to capture at least one of audio data or video data at the location;
receive, via the communication interface, surveillance information from the surveillance device; and
send the surveillance information to the medical personnel device.

18. The device of claim 16, wherein the one or more processors and/or circuits are further configured to:
send, via the communication interface, a health status request to the inmate device; and
receive, via the communication interface, a health status reply from the inmate device.

19. The device of claim 16, wherein the one or more processors and/or circuits are further configured to:
determine an estimated health diagnosis based on the wellness information; and
wherein the emergency response information further includes the estimated health diagnosis.

20. The device of claim 1, wherein the wellness information includes at least one of heart rate information, oxygen information, and body temperature information.
